(19) United States
(12) Patent Application Publication
(10) Pub. No.: US 2017/0261798 A1
(43) Pub. Date: Sep. 14, 2017

(54) LIQUID CRYSTAL DISPLAY SCREEN AND MANUFACTURING METHOD OF LONG STRIP LIQUID CRYSTAL DISPLAY SCREEN

(71) Applicant: Shenzhen China Star Optoelectronics Technology Co., Ltd., Guangdong (CN)

(72) Inventor: Quan LI, Guangdong (CN)

(21) Appl. No.: 14/910,697

(22) PCT Filed: Jan. 8, 2016
(86) PCT No.: PCT/CN2016/070490

§ 371 Date: Feb. 6, 2016

(30) Foreign Application Priority Data
Nov. 9, 2015 (CN) 201510754981.3

(51) Int. Cl. G02F 1/1345

(52) U.S. Cl. CPC G02F 1/13452

(57) ABSTRACT

A liquid crystal display screen, wherein the liquid crystal display screen includes a liquid crystal panel which includes a display region and line connection regions located in the periphery of the display region; wherein the line connection regions located at an upper side surface and a lower side surface of the display region are connected to a source driving module, respectively, and two source driving modules may independently provide data signals to the liquid crystal panel; and a line connection region located at a left side surface of the display region is connected to a gate driving module to provide scan signals to the liquid crystal panel. The liquid crystal display screen is mainly applied to manufacturing a long strip liquid crystal display screen and improves utilization ratio of the liquid crystal display screen through improvement on structure of the liquid crystal display screen.

### TECHNICAL FIELD

The present disclosure relates to a liquid crystal display technical field, more particularly, to a liquid crystal display screen and a manufacturing method of a long strip liquid crystal display screen.

### BACKGROUND ART

A Liquid Crystal Display (LCD) is a display apparatus of which a panel is ultra-thin, which is composed of a certain amount of colorful or black-and-white pixels and disposed in front of a light source or a reflection plate. Power consumption of the liquid crystal display is very low, and the liquid crystal display has characteristics such as high image quality, small volume and low weight, which is accordingly highly appreciated and becomes a mainstream of displays.

A liquid crystal display screen is an important component of the liquid crystal display, referring to FIG. 1, the liquid crystal display screen mainly includes a liquid crystal panel 1, a source driving module 2 for providing data signals to the liquid crystal panel 1 and a gate driving module 3 for providing data signals to the liquid crystal panel 1. Generally, the source driving module 2 is disposed at an upper side surface of the liquid crystal panel 1, as illustrated in FIG. 1, the source driving module 2 includes a Printed Circuit Board (PCB) 21 and a plurality of Chip On Films (COFs) 22 which are connected to the printed circuit board 21 and the liquid crystal panel 1 to transmit a data signal generated by the printed circuit board 21 to the liquid crystal panel 1, and both ends of the COF 22 are generally connected to a glass substrate electrode of the liquid crystal panel 1 and an electrode of the printed circuit board 21 using a heat pressing technique, respectively. As illustrated in FIG. 1, the gate driving module 3 is generally disposed at a left side surface of the liquid crystal panel 1 and includes a plurality of gate driving chips 31 which may be directly connected to a glass substrate on the liquid crystal panel 1 through a Chip On Glass (COG) process.

In the commercial liquid crystal display, there is a long strip liquid crystal display screen widely applied to digital indications, for example, a Taxi advertisement, a window indication of an administration service hall, signs for directions of airport terminals or high speed rail stations and shopping mall indication, etc. A length-width ratio of the long strip liquid crystal display screen is generally 16:3 and 16:4, etc., and a method of obtaining such unconventional liquid crystal display screen is generally cutting a current liquid crystal display screen with a current length-width ratio of 16:9 to reserve 1/3, 1/4 or 1/2 thereof, etc. Referring to FIGS. 1 and 2, the liquid crystal display screen as illustrated in FIG. 2 is cut (cutting along an X line) to a long strip liquid crystal display screen, the side having the source driving module 2 is necessarily reserved, if the side of the liquid crystal panel 1 closing to the source driving module 2 has bad display points, the liquid crystal display screen cannot be used to process a long strip liquid crystal display screen. Also, an original liquid crystal display screen can be only cut to obtain a long strip liquid crystal display screen, and a relatively large area is cut, thereby causing waste.

### SUMMARY

Due to deficiency existing in the prior art, the present disclosure provides a liquid crystal display screen, which is mainly applied to manufacturing a long strip liquid crystal display screen and improves utilization ratio of the liquid crystal display screen through improvement on structure of the liquid crystal display screen.

In order to achieve the above purpose, the following technical solution used by the present disclosure is:

A liquid crystal display screen, wherein the liquid crystal display screen includes a liquid crystal panel which includes a display region and line connection regions located in the periphery of the display region; wherein the line connection regions located at an upper side surface and a lower side surface of the display region are connected to a source driving module, respectively, and two source driving modules may independently provide data signals to the liquid crystal panel; and a line connection region located at a left side surface of the display region is connected to a gate driving module to provide scan signals to the liquid crystal panel.

Wherein the source driving module includes a printed circuit board and a plurality of Chip On Films (COFs), both ends of the Chip On Film are electrically connected to the printed circuit board and the line connection regions of the liquid crystal panel, respectively; the Chip On Films are disposed with source driving chips.

Wherein the gate driving module includes a plurality of gate driving chips which are directly connected to the line connection regions of the liquid crystal panel through a COG process.

Wherein the liquid crystal display screen is used to manufacture a long strip liquid crystal display screen whose length-width ratio is smaller than the length-width ratio of the liquid crystal display screen.

Wherein the length-width ratio of the liquid crystal display screen is 16:9.

Wherein the length-width ratio of the long strip liquid crystal display screen is 16:3 or 16:4.

Wherein some bad display points randomly exist in the display region of the liquid crystal panel.

The present disclosure further provides a manufacturing method of a long strip liquid crystal display screen, wherein the above-mentioned liquid crystal display screen is cut along a transverse direction to obtain a long strip liquid crystal display screen.

Compared with the prior art, the liquid crystal display screen provided in the embodiments of the present disclosure is disposed with independent source driving modules at an upper side surface and a lower side surface, respectively, when the liquid crystal display screen is applied to manufacturing a long strip liquid crystal display screen, and when the region at an upper side or a lower side of the liquid crystal panel of the liquid crystal display screen contains bad display points, the liquid crystal display screen may also be cut to a long strip liquid crystal display screen, and when bad display points are located at an intermediate region of the liquid crystal panel, the liquid crystal display screen may be cut to two long strip liquid crystal display screens, which improves utilization ratio of the liquid crystal display screen.

### BRIEF DESCRIPTION OF THE DRAWINGS

FIG. 1 is a structural schematic diagram of a current liquid crystal display screen;

FIG. 2 is an exemplary graphic of cutting a liquid crystal display screen as illustrated in FIG. 1 to a long strip liquid crystal display screen;

FIG. 3 is a structural schematic diagram of a liquid crystal display screen provided by an embodiment of the present disclosure;

FIG. 4 is an exemplary graphic of a first situation of cutting a liquid crystal display screen as illustrated in FIG. 3 to a long strip liquid crystal display screen;

FIG. 5 is an exemplary graphic of a second situation of cutting a liquid crystal display screen as illustrated in FIG. 3 to a long strip liquid crystal display screen; and

FIG. 6 is an exemplary graphic of a third situation of cutting a liquid crystal display screen as illustrated in FIG. 3 to a long strip liquid crystal display screen;

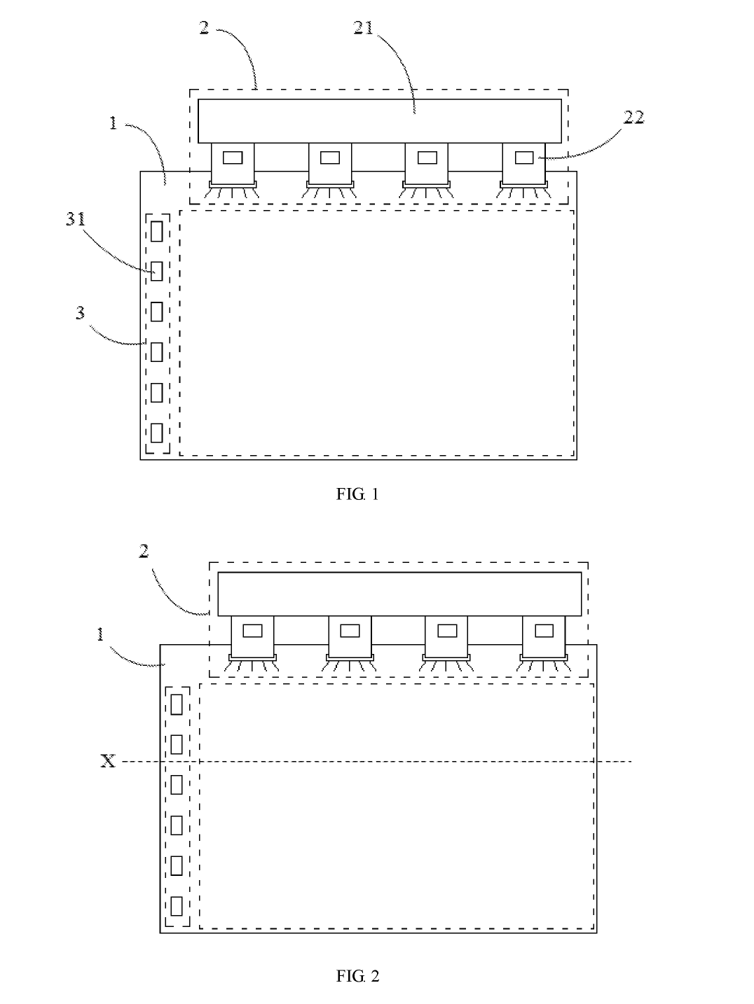

### DETAILED DESCRIPTION OF EXEMPLARY EMBODIMENTS

In order for the purpose, technical solution and advantages of the present disclosure to be clearer and understood, the exemplary embodiments of the present disclosure will be further explained in detail below in conjunction with the figures. The examples of these preferred embodiments are illustrated in the drawings. The embodiments of the present disclosure illustrated in the drawings and described according to the drawings are only exemplary, and the present disclosure is not limited to these embodiments.

Here, it needs to be further explained that in order to avoid causing the present disclosure to be vague due to unnecessary details, the structures and/or processes closely related to the solution of the present disclosure are only illustrated in the drawings, while other details which are of less concern about the present disclosure are omitted.

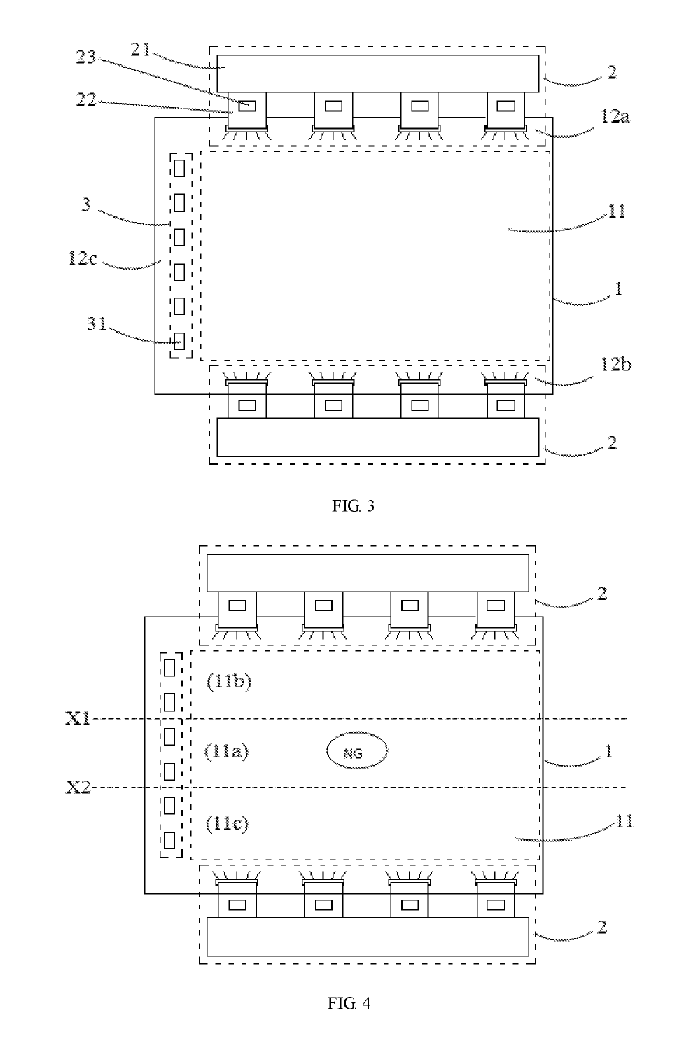

The present embodiment provides a liquid crystal display screen, as illustrated in FIG. 3, the liquid crystal display screen includes a liquid crystal panel 1 which includes a display region 11 and line connection regions 12a, 12b and 12c located in the periphery of the display region 11. Wherein the line connection regions 12a and 12b located at an upper side surface and a lower side surface of the display region 11 are connected to a source driving module 2, respectively, and two source driving modules 2 may independently provide data signals to the liquid crystal panel 1. A line connection region 12c located at a left side surface of the display region 11 is connected to a gate driving module 3 to provide scan signals to the liquid crystal panel 1.

Particularly, the source driving module 2 includes a printed circuit board 21 and a plurality of Chip On Films (COFs) 22 on which are disposed with source driving chips 23, and the Chip On Films 22 driving IC (source driving chips 23) are formed by fixing onto a flexible circuit board, that is, Chip On Film (COF). Both ends of the Chip On Film 22 are electrically connected to the printed circuit board 21 and the line connection regions 12a and 12b of the liquid crystal panel 1, respectively, and both ends of the Chip On Film 22 are generally connected to electrodes of the line connection regions 12a and 12b of the liquid crystal panel 1 and an electrode of the printed circuit board 21 using a heat pressing technique, respectively.

Particularly, the gate driving module 3 includes a plurality of gate driving chips 31 which are directly connected to the line connection region 12c of the liquid crystal panel 1 through a Chip On Glass (COG) process.

A length-width ratio of the liquid crystal display screen having the above structure is generally 16:9 which is mainly used to manufacture a long strip liquid crystal display screen. The length-width ratio of the long strip liquid crystal display screen is smaller than the length-width ratio of the liquid crystal display screen, and the length-width ratio of the long strip liquid crystal display screen is 16:3 or 16:4. The long strip liquid crystal display screen with a length-width ratio of 16:3 or 16:4 is obtained by cutting the liquid crystal display screen with a length-width ratio of 16:9.

The liquid crystal panel 1 used by the liquid crystal display screen in the present embodiment is generally found with existence of bad display points during the processing of the liquid crystal panel, and these bad display points randomly exist in the display region 11 of the liquid crystal panel 1.

The above provided liquid crystal display screen is cut in a transverse direction to obtain a long strip liquid crystal display screen. Taking a length-width ratio of a liquid crystal display screen which is 16:9 and a length-width ratio of a long strip liquid crystal display screen to be manufactured which is 16:3 as a particular example, it mainly contains the following situations:

(1) As illustrated in FIG. 4, bad display points do not exist in the display region 11 of the liquid crystal panel 1, or when bad display points (NG) are located in an intermediate region 11a of the display region 11, the liquid crystal panel 1 is cut in a transverse direction (along lines X1 and X2 in FIG. 4) to obtain two pieces of long strip liquid crystal display screens. The source driving module 2 at an upper side surface and a region 11b in the display region 11 of the liquid crystal panel 1 form one long strip liquid crystal display screen; and the source driving module 2 at a lower side surface and a region 11c in the display region 11 of the liquid crystal panel 1 form another long strip liquid crystal display screen.

(2) As illustrated in FIG. 5, when bad display points (NG) are located in the region 11b closing to an upper side of the display region 11 (or bad display points also exist in the region 11a simultaneously), the liquid crystal panel 1 is cut in a transverse direction (along line X2 in FIG. 5) to obtain a long strip liquid crystal display screen. The source driving module 2 at a lower side surface and a region 11c in the display region 11 of the liquid crystal panel 1 form a long strip liquid crystal display screen.

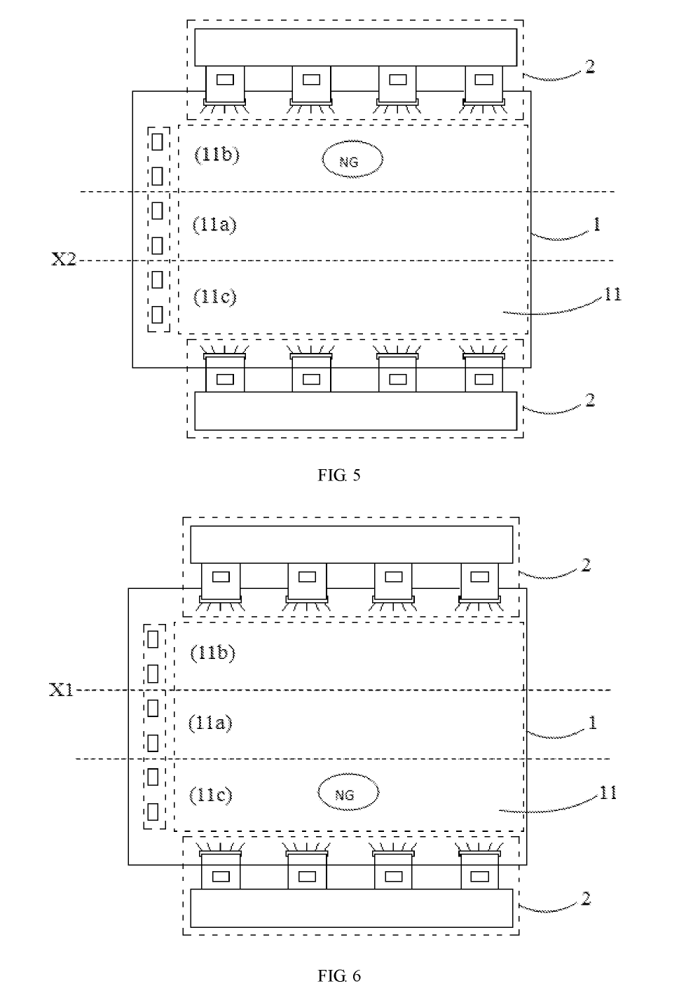

(3) As illustrated in FIG. 6, when bad display points (NG) are located in the region 11c closing to a lower side of the display region 11 (or bad display points also exist in the region 11a simultaneously), the liquid crystal panel 1 is cut in a transverse direction (along line X1 in FIG. 6) to obtain a long strip liquid crystal display screen. The source driving module 2 at an upper side surface and a region 11b in the display region 11 of the liquid crystal panel 1 form a long strip liquid crystal display screen.

In addition, if upper, intermediate and lower regions 11a, 11b and 11c in the display region 11 all have bad display points, the liquid crystal display screen is scrapped. Generally, supposing that upper, intermediate and lower regions 11a, 11b and 11c in the display region 11 of the liquid crystal panel all have bad display points, when processing these bad display points during the processing of the liquid crystal panel, the further processing will not be performed to form the liquid crystal display screen as provided by the present embodiment.

In conclusion, the liquid crystal display screen provided in the embodiments of the present disclosure is disposed with independent source driving modules at an upper side surface and a lower side surface, respectively, when the liquid crystal display screen is applied to manufacturing a long strip liquid crystal display screen, and when the region at an upper side or a lower side of the liquid crystal panel of the liquid crystal display screen contains bad display points, the liquid crystal display screen may also be cut to obtain a long strip liquid crystal display screen, and when bad display points are located at an intermediate region of the liquid crystal panel, the liquid crystal display screen may be cut to two long strip liquid crystal display screens, which improves utilization ratio of the liquid crystal display screen.

It should be explained that the relationship terms, such as first and second, etc., in the present text are only used for distinguishing one entity or operation from another entity or operation without requiring or implying any actual relation or sequence existing between these entities or operations. Moreover, the term “include”, “contain” or any other variant means covering instead of exclusively including, so that the process, method, object or device including a series of factors not only includes those factors but also includes other factors that are not explicitly listed or further include inherent factors for this process, method, object or device. Where no more limitations are provided, the factors defined by the sentence “include one . . . ” do not exclude additional identical factors existing in the process, method, object or device which includes the factors.

The above statements are only the specific embodiments of the present application, it should be pointed out that, to those ordinary skilled in the art, several improvements and polish can be made without breaking away from the principle of the present application, also those improvements and polish should be considered as the protection scope of the present application.

1. A liquid crystal display screen, comprising a liquid crystal panel which comprises a display region and line connection regions located in the periphery of the display region; wherein the line connection regions located at an upper side surface and a lower side surface of the display region are connected to a source driving module, respectively, and two source driving modules independently provide data signals to the liquid crystal panel; and a line connection region located at a left side surface of the display region is connected to a gate driving module to provide scan signals to the liquid crystal panel.

2. The liquid crystal display screen according to claim 1, wherein the source driving module comprises a printed circuit board and a plurality of Chip On Films (COFs), both ends of the Chip On Film are electrically connected to the printed circuit board and the line connection regions of the liquid crystal panel, respectively; and source driving chips are disposed on the Chip On Films.

3. The liquid crystal display screen according to claim 1, wherein the gate driving module comprises a plurality of gate driving chips which are directly connected onto the line connection regions of the liquid crystal panel through a COG process.

4. The liquid crystal display screen according to claim 1, wherein the liquid crystal display screen is used to manufacture a long strip liquid crystal display screen whose length-width ratio is smaller than the length-width ratio of the liquid crystal display screen.

5. The liquid crystal display screen according to claim 1, wherein the length-width ratio of the liquid crystal display screen is 16:9.

6. The liquid crystal display screen according to claim 5, wherein the length-width ratio of the long strip liquid crystal display screen is 16:3 or 16:4.

7. According to the liquid crystal display screen of claim 5, wherein some bad display points randomly exist in the display region of the liquid crystal panel.

8. The liquid crystal display screen according to claim 2, wherein the length-width ratio of the liquid crystal display screen is 16:9.

9. The liquid crystal display screen according to claim 7, wherein the length-width ratio of the long strip liquid crystal display screen is 16:3 or 16:4.

10. The liquid crystal display screen according to claim 8, wherein some bad display points randomly exist in the display region of the liquid crystal panel.

11. A manufacturing method of a long strip liquid crystal display screen, wherein a liquid crystal display screen is cut along a transverse direction to obtain a long strip liquid crystal display screen; wherein the liquid crystal display screen comprises a liquid crystal panel which comprises a display region and line connection regions located in the periphery of the display region; wherein the line connection regions located at an upper side surface and a lower side surface of the display region are connected to a source driving module, respectively, and two source driving modules independently provide data signals to the liquid crystal panel; and a line connection region located at a left side surface of the display region is connected to a gate driving module to provide scan signals to the liquid crystal panel.

12. The manufacturing method according to claim 11, wherein the source driving module comprises a printed circuit board and a plurality of Chip On Films (COFs), both ends of the Chip On Film are electrically connected to the printed circuit board and the line connection regions of the liquid crystal panel, respectively; and the Chip On Films are disposed with source driving chips.

13. The manufacturing method according to claim 11, wherein the gate driving module comprises a plurality of gate driving chips which are directly connected onto the line connection regions of the liquid crystal panel through a COG process.

14. The manufacturing method according to claim 11, wherein the liquid crystal display screen is used to manufacture a long strip liquid crystal display screen whose length-width ratio is smaller than the length-width ratio of the liquid crystal display screen.

15. The manufacturing method according to claim 11, wherein the length-width ratio of the liquid crystal display screen is 16:9.

16. The manufacturing method according to claim 15, wherein the length-width ratio of the long strip liquid crystal display screen is 16:3 or 16:4.

17. The manufacturing method according to claim 15, wherein some bad display points randomly exist in the display region of the liquid crystal panel.

18. The manufacturing method according to claim 12, wherein the length-width ratio of the liquid crystal display screen is 16:9.

19. The manufacturing method according to claim 17, wherein the length-width ratio of the long strip liquid crystal display screen is 16:3 or 16:4.

20. The manufacturing method according to claim 18, wherein some bad display points randomly exist in the display region of the liquid crystal panel.
